(19) United States
(12) Patent Application Publication
(10) Pub. No.: US 2004/0109751 A1
(43) Pub. Date: Jun. 10, 2004

(54) Substrate processing system

(76) Inventors: Preston Whitcomb, Hull, MA (US); John Jamieson, Santa Barbara, CA (US)

Correspondence Address: FISH & RICHARDSON PC, 225 FRANKLIN ST, BOSTON, MA, 02110, US

(21) Appl. No.: 10/645,963

(22) Filed: Aug. 22, 2003

Related U.S. Application Data
(60) Provisional application No. 60/405,568, filed on Aug. 22, 2002.

(51) Int. Cl. B66C 23/00

(52) U.S. Cl. 414/744.1

(57) ABSTRACT

A system comprising a first robotic arm assembly for capturing and releasing a semiconductor wafer, a second robotic arm for capturing and releasing an interleaf, and a controller for actuation of the first and second robotic arms, the first and second robotic arms operating substantially simultaneously. At least one robotic arm can include a transfer arm, and a counterweight attached to a first end of the transfer arm and an end effector attached to a second, opposite end of the transfer arm. Two robotic arms permit the system to carry out the steps substantially simultaneously and therefore increase throughput significantly.

### CROSS-REFERENCE TO RELATED APPLICATION

This application claims priority to U.S. Provisional Application Serial No. 60/405,568, filed Aug. 22, 2002, the entire contents of which is incorporated herein by reference.

### TECHNICAL FIELD

This invention relates to a substrate processing system.

### BACKGROUND

Processing of a single semiconductor wafer often takes place in multiple fabrication facilities. Systems have been developed that are capable of sorting, tracking and packing/unpacking substrates to and from shipping containers. Such systems require handling of semiconductor wafers as well as other packaging materials such as an interleaf materials into and out of the shipping containers. The interleaf material is placed between the wafers to protect and space the wafers and minimize contact between each wafer. Generally, wafers and interleafs are both placed horizontally into the shipping containers. The shipping container is typically a rigid open container that is slightly larger than the diameter of the substrate and is deep enough to support about twenty-five wafers per container.

Systems for packing and unpacking substrate material often utilize vacuum wands and commercially available robotic systems. Such robotic systems can include one robotic arm assembly carrying multiple end effectors of different designs tailored to the needs of the specific substrate (e.g., wafer or interleaf).

The packing and unpacking of wafers into and out of enclosures known as horizontal wafer shipping containers is a sequential process with one process step being conducted at a time. The number of steps and the speed with which the robotic transfer arm can process each step can determine the packing and unpacking speed and the system throughput.

### SUMMARY

In one aspect, the invention features a first robotic arm assembly for capturing and releasing a semiconductor wafer and having at least two degrees of freedom, a second robotic arm for capturing and releasing an interleaf and having at least two degrees of freedom, and a controller for actuation of the first and second robotic arms, the first and second robotic arms operating substantially simultaneously.

In one embodiment, the second robotic arm includes a transfer arm having a first end and a second end, and mounted to a second arm base, a counterweight attached to the first end of the transfer arm, and an end effector attached to the second, opposite end of the transfer arm.

In another embodiment, the end effector of the system is configured to apply variable pressure forces to capture and release the interleaf. In another embodiment, the end effector of the system is configured to sequentially apply negative and positive pressures to capture and release the interleaf. In another embodiment, the system further includes a sensor to detect a proximity and engagement of the interleaf with the end effector. In still another embodiment the sensor uses differential pressure, reflectance, imaging, capacitance or inductance to detect proximity and engagement of the interleaf.

In another embodiment, the system includes a sensor to detect the material properties of the interleaf. In another embodiment, the sensor of the system uses differential pressure, reflectance, imaging, capacitance or inductance to detect the material properties of the interleaf. In another embodiment, the end effector arm further comprises electrodes to provide an electrostatic charge for capturing the interleaf. In another embodiment, the end effector is slidably disposed in a substantially vertical orientation at the second end of the transfer arm. In another embodiment, the end effector is configured to vertically actuate independently of the base. The robotic arms can be, for example, pneumatically actuated or actuated with electric servo motors. In one embodiment, the system includes an interleaf cassette holder having a pneumatic separator for separation of the interleafs.

In another aspect, an assembly includes a transfer arm having a first end and a second end, the arm being mounted to a second arm base, a counterweight attached to the first end of the transfer arm, and an end effector attached to the second, opposite end of the transfer arm, the end effector configured to apply positive and negative pressures to a substrate. In one embodiment, the end effector of the system is configured to sequentially apply positive and negative pressures to the substrate. The robotic arm assembly can also include a sensor to detect the material properties of the substrate when coupled to the end effector.

In another aspect, the invention features a method including providing a processing system having first and second robotic arms, the first robotic arm having a first end effector for capture and release of a semiconductor wafer, the second robotic arm having a second end effector for the capture and release of an interleaf sheet, positioning the second robotic arm such that the second end effector is proximate to interleaf sheets, applying a positive pressure through the second end effector to the interleaf sheets to separate an upper-most interleaf sheet from remaining sheets, applying a negative pressure through the second end effector to retain the upper-most interleaf sheet against the second end effector, and transporting the upper-most interleaf sheet from a first location to a second location, and releasing the upper-most interleaf sheet from the second end effector.

In one embodiment, the interleaf sheet is released into a enclosure and the method further includes positioning the first robotic arm for capturing the semiconductor wafer from a first location and releasing the semiconductor wafer to a second location within a wafer shipper before each release of the upper-most interleaf sheet from the second end effector. In another embodiment, the method includes capturing the semiconductor wafer by applying negative pressure through the first end effector and releasing the wafer by applying ambient pressure through the first end effector.

The systems and methods according to the invention provide at least improved interleaf transfer reliability and contamination control through the use of multiple robotic arm assemblies with at least one robotic arm including a Bernoulli end effector. This configuration allows performance of the steps substantially simultaneously rather than sequentially and therefore increase the system throughput significantly. One robotic arm assembly can be configured for each step of the sequence for enhanced speed and throughput. In one embodiment, one robotic arm is dedicated towards the handling of wafers and another robotic arm is dedicated to the handling of interleafs only. Each of the first and second robotic arms can be configured to handle either wafers or interleaf sheets.

The system may be used to both pack and unpack the wafer shippers. Accordingly, identical systems may be located in both a shipping and receiving area of a semiconductor fabrication facility. The system also provides faster loading of semiconductor wafers than is possible with manual loading using an electrostatic or vacuum wand and affords the capability of loading wafers more reliably and with less breakage than manual loading.

### DESCRIPTION OF DRAWINGS

FIG. 1 is a perspective view of a system for wafer processing.

FIG. 2 is a perspective view of a top portion of the system of FIG. 1.

FIG. 3 is a plan view of the system of FIG. 1.

FIG. 4A is a side view of the transfer arm including an end effector of the system depicted in FIG. 1 positioned proximate to an interleaf cassette.

FIG. 4B is a side view of the transfer arm of FIG. 4A engaging a cassette of interleafs.

FIG. 5A is a detail view of the end effector of the transfer arm engaging an interleaf.

FIG. 5B is a detail view of end effector of FIG. 5A withdrawing an interleaf from the cassette.

FIG. 5C is a detail view of the end effector of FIG. 5A holding an interleaf.

FIGS. 6A-6C are schematic views of various embodiments of one end of the end effector of the transfer arm.

FIGS. 7A and 7B are detail views of a wafer shipper.

FIG. 8 is a flow chart representing exemplary process steps for the system of FIG. 1.

Like reference symbols in the various drawings indicate like elements.

### DETAILED DESCRIPTION

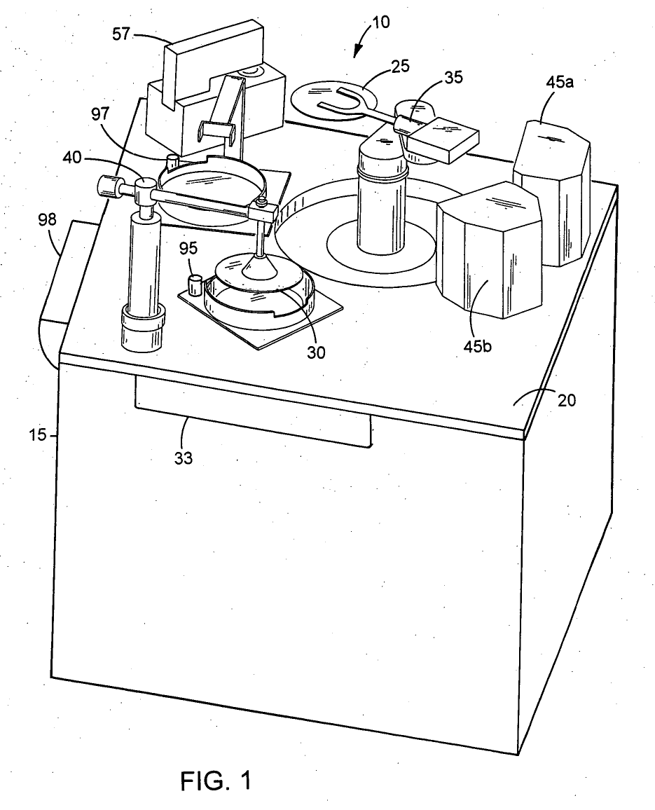

Referring to FIG. 1, a processing system 10 includes an enclosure 15 and an operation area 20 for the processing of substrate materials including, for example, a semiconductor wafer 25 and an interleaf sheet 30. The enclosure 15 can include a drawer 33 for a keyboard and flat panel display system having a graphical user interface (GUI) for user input to a system computer (not shown). The enclosure 15 can also house a number of ancillary components including, for example, power supply, a computer, pneumatic pump and controller, and storage (not shown). In one example, the system 10 is configured for complete processing of the semiconductor wafers 25 for routing through multiple fabrication facilities. As semiconductor wafers 25 have grown increasingly larger and thinner, the loading and unloading of the wafers 25 has become concomitantly more exacting. An important consideration in thin wafer design is that the wafer 25 is flexible and can be readily flattened and transported.

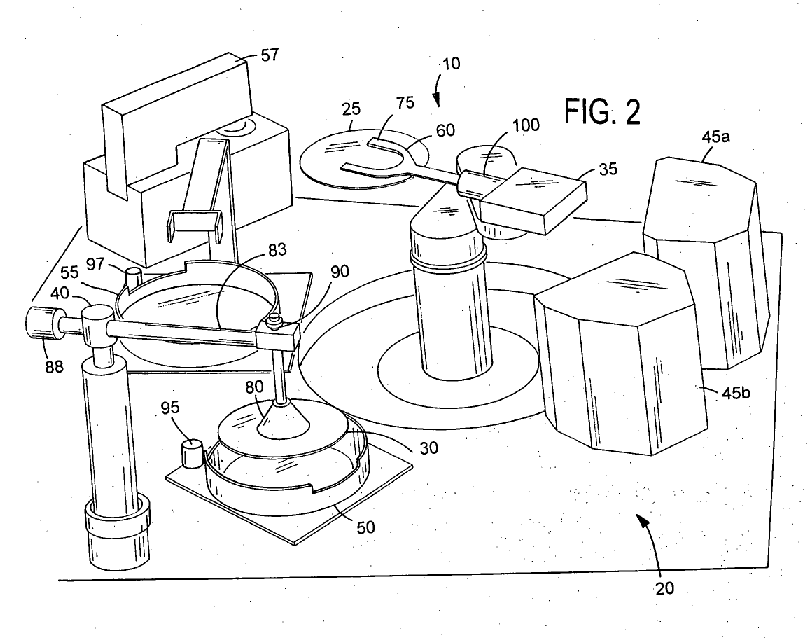

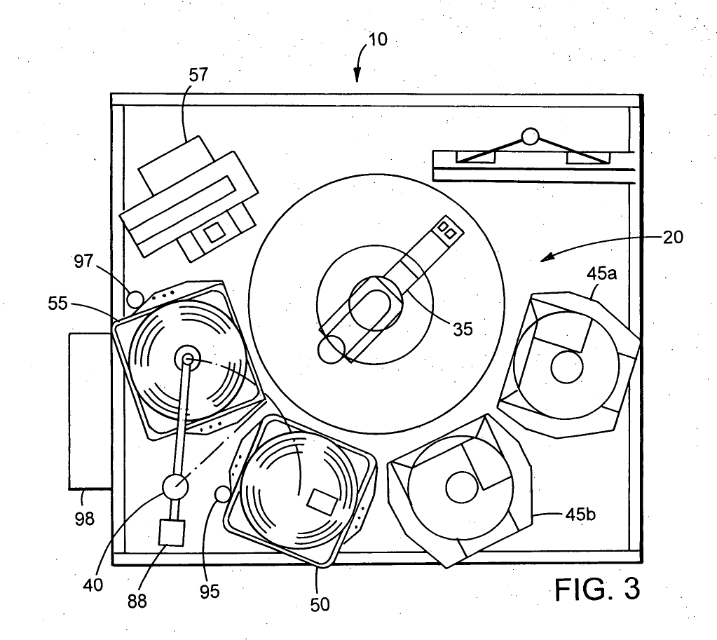

Referring to FIGS. 2 and 3, the operation area 20 includes an articulated robotic arm (wafer arm) 35, a transfer arm 40, universal cassettes 45a, 45b, an interleaf holder 50, a horizontal wafer shipper 55, and a prealigner 57. The wafer arm 35 can be controlled by a Motoman ERC robot controller, for example. In one example, the prealigner 57 is an Integrated Dynamics Engineer SPA 310 prealigner (sorter version) and includes a prealigner controller (not shown). The prealinger 57 can also include inspection capability such as a Cognex Insight 1700 vision system or an inspection station for detecting defects on the surface of the wafer 25. The vision system can automatically adjust for differing diameters of the wafer 25. In one example, the system 10 includes a wafer scanner (not shown). The horizontal wafer shipper 55 is also known as a “coin-pack” (CP) cassette or a “Jar”. In one example, the wafer arm 35 includes a wafer end effector 60 attached to an end of extender 65. In one example, the wafer arm 35 is a Robot ROB 310 and the wafer end effector 60 is a flipper-type end effector.

The system 10 can also include an ionization riffler 95 disposed on the operation area 20 adjacent to the interleaf holder 50 or an ionization riffler 97 disposed adjacent to the horizontal wafer shipper 55. An interleaf recycle bin 98 (FIG. 1) can be attached to the enclosure 15 adjacent to the interleaf holder 50 and horizontal wafer shippers 55 for discarding the interleaves during unpacking of wafer shipper 55.

In one example, the wafer arm 35 removes a semiconductor wafer 25 from either of the two universal cassettes 45a, 45b, by extending the wafer end effector 60 to engage a back side 75 of the semiconductor wafer 25, using, for example, vacuum pressure to hold the wafer 25 for transport to the wafer shipper 55. In one example, the transfer arm 40 uses a combination of vacuum and positive pressures to retrieve the interleaf sheet 30 from the interleaf holder 50 for transport to the wafer shipper 55.

In operation, the wafer arm 35 grasps a wafer 25 from either of the two universal cassettes 45a, 45b and places the wafer 25 onto the prealigner 57, if an identification reading of the wafer 25 is required. In some examples, the wafers 25 are placed into either the wafer shippers 55 of the two universal cassettes 45a, 45b in predetermined orientations. In some examples, the wafer 25 is asymmetric and the prealinger 57 detects this asymmetry while rotating the wafer 25. The prealinger 57 can then rotate the wafer 25 to a predetermined orientation as a function of the asymmetry. The wafer arm 35 picks up the wafer 25 by applying vacuum pressure at the wafer end effector 60, flip the wafer 25 upside down, and moves the wafer 25 over the wafer shipper 55. The wafer arm 35 then releases the wafer 25 to allow the wafer 25 to float gently down onto the stack of wafers 25 in the wafer shipper 55. A sensor (not shown) can be provided to check for a correct presence of an interleaf sheet 30 before releasing the wafer 25 into the wafer shipper 55.

Sensors scan the wafer shipper 55 loaded with a stack of wafers 25 and interleaf sheets 30 to provide a stack height. The wafer arm 35 descends towards the wafer 25 and moves into slow mode with predefined steps as it approaches the back side 75 of the wafer 25. Actuating the riffler 97 causes compressed air to flow from a number of apertures in the riffler and separates and floats a top wafer 25 up against the wafer end effector 60 so that when a vacuum is established between the wafer end effector 60 and the wafer 25, the wafer arm 35 will move up and retract thereby retrieving the wafer 25.

Some examples of the system 10 may include a warning system during loading or unloading of a wafer shipper 55 to prevent damage to the wafers 25. For example, if either the wafer or interleaf end effectors 60, 80 presses against the top of a stack and does not cause a detectable change in vacuum flow, continued lowering of either the wafer or transfer arms 35, 40 can damage or break a wafer 25, and can also cause the stack or wafers 25 to bind together, making it difficult to remove the wafers 25. In one embodiment, this warning condition is avoided by using a counter (not shown) that is decremented as each wafer 25 and/or interleaf sheet 30 is unloaded, the count usable to determine the remaining height of the respective substrates.

When lifting the wafer 25 from the shipper 55, a variable pause in the movement of the wafer arm 35 can be incorporated to allow any double wafer lifts to drift back after any static charges have bled away from the coupled wafers 25. In some examples, this is a precaution followed even when utilizing the riffler 97. In one example, the wafer arm 35 only lifts the wafer 35 a small distance before pausing. In one example, as the wafer arm 35 is approaching the stack, the riffler 97 is actuated when the wafer end effector 60 is approximately about 2 mm above the wafer 25 to prevent any wafers 25 from being displaced out of the wafer shipper 55.

The interleaf sheet 30 is then placed into the wafer shipper 55 with the wafer arm 35 or transfer arm 40. The acquisition sequence for both wafers 25 and interleafs sheets 30 is the same. However, a difference between handling the wafers 25 and the interleaf sheets 30 involves a mid air transfer of the wafer 25 prior to placement of the wafer 25 in the wafer shipper 55 or returning the wafer 55 to the cassettes 45a, 45b. The unpacking operation is the same as described above with the sequence is reversed.

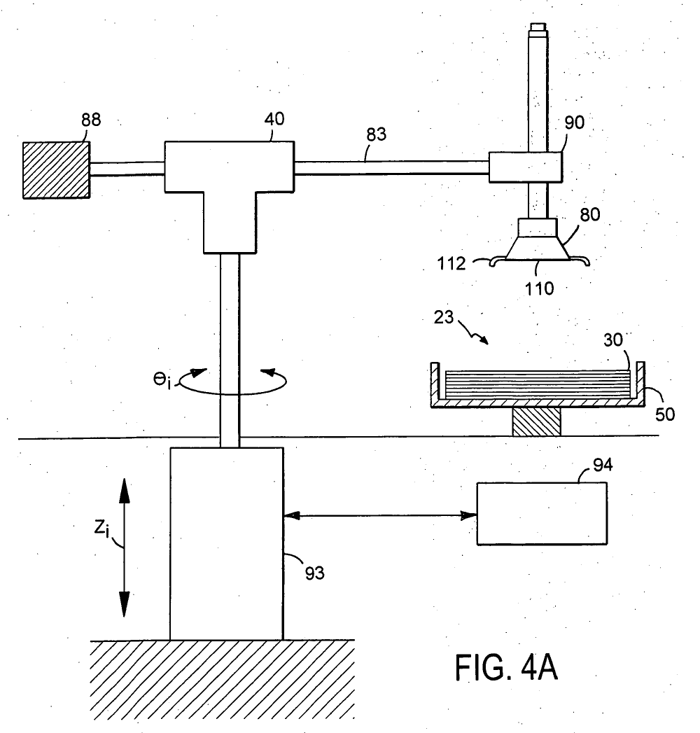

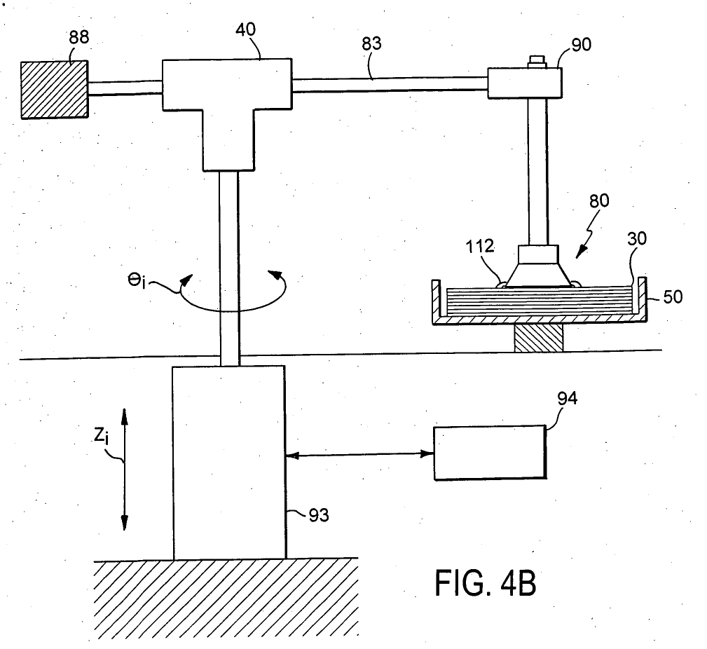

Referring to FIGS. 4A and 4B, the transfer arm 40 and interleaf holder 50 are shown. The transfer arm 40 defines two motion axes, Zᵢ and θᵢ, enabling vertical and rotational motion, respectively. The interleaf end effector 80 can be used for transferring both wafers 25 and interleaf sheets 30. The interleaf end effector 80 is vertically deployed and makes contact with the a top surface of a substrate being transferred. The interleaf end effector 80 applies some type of grasping force that is greater than a weight of the substrate to be transferred. The technique used to develop the grasping force at the interleaf end effector 80 can be achieved in several different ways depending upon the type of substrate to be handled.

In one example, the transfer arm 40 includes an interleaf end effector 80 attached to a first end of an extender 83 and a counterweight 88 is attached to a second, opposite end of the extender 83. The transfer arm 40 can also include a linear bearing 90 to permit independent vertical movement of the end effector 80 for facilitating engaging and dropping interleaf sheets 30. The transfer arm 40 can include an actuator base 93 to provide movement in the Zᵢ and θᵢ directions. The actuator base 93 is connected to a controller 94 linked to the system computer (not shown). In various embodiments, the actuator base 93 is pneumatically actuated or utilizes electric servo motors having either direct drive or a transmission linkage to the transfer arm 40.

Typically, the system 10 includes position feed back sensors and/or switches (not shown) associated with the wafer arm 35 and/or the transfer arm 40 that are received as inputs to and controlled by the system computer. In one example, the transfer arm 40 is cushioned and can rotate through an arc of 135 degrees in the θᵢ direction and has a vertical movement of about 3.5 inches in the Zᵢ direction. Other dynamic parameters for the transfer arm 40 can be used.

In one example, a sensor is used to detect a change in the vacuum applied at the interleaf end effector 80. Therefore, during operation, as the interleaf end effector 80 is lowered towards the interleaf sheets 30, a detected change of a certain magnitude in a vacuum pressure level is recognized as indicating that the interleaf end effector 80 has contacted a top interleaf 30 in the stack. This detected change in vacuum causes an interrupt at the system computer, which, in turn, causes the system computer to raise the end effector 80 away from the interleaf stack 30, and permit the transfer arm 40 to retrieve and retain only one interleaf sheet 30. In this way, the vacuum change prevents the end effector 80 from pressing the interleaf sheets 30 together and minimizes the development of an electrostatic bond between multiple interleaf sheets 30. This manner of picking up the interleaf sheets 30 is referred to as a “feather touch mode” material handling. The system 10 can also be configured so that the transfer arm 40 descends slowly towards the interleaf stack 30 and moves up relatively quickly to promote disengagement of the interleaf sheet 30 from the interleaf end effector 80 of the transfer arm 40.

A difficulty in handling substrates such as interleaves 30 and wafers 25 is adhesion that can develop between successive substrates caused by static forces. Using ionization rifflers 95, 97 to separate the interleaf sheets 30 and the wafers 25 in conjunction with the “feather touch mode” described above can be effective in reducing these static adhesion forces. The rifflers 95, 97 provide a flow or pressurized gas, air for example, through a number of holes in the rifflers 95, 97, to the wafers 25 and the substrates 30 in a generally radially inward direction.

In one example, the interleaf end effector 80 can be configured to cause a slight deformation of an interleaf 30 in order to further separate the interleaf sheets 30 and reduce electrostatic bonding between the interleaf sheets 30. This can be accomplished, for example, by forming a curvature in a diffuser 10 attached to the interleaf end effector 80 and/or with the addition of outriggers 112 for deflection of the interleaf 30 following capture by the interleaf end effector 80. The outriggers 112 can extend radially outward and downward along a circumferential surface of the diffuser 10 to deflect the interleaf sheets 30 upon engagement with the end effector 80.

Certain physical characteristics of the interleaf sheet 30 can make handling difficult. Specifically, a porosity of the interleaf sheet 30 lessens an effectiveness of the interleaf end effector 80. In this case, it is possible to unintentionally pick up more than one interleaf sheet 30 at a time due to a vacuum bleeding through the interleaf sheets 30. A wide variation in porosity of the interleaf sheet 30 prevents use of controlled vacuum flow to pick up single interleaf sheets 30 and use of the vacuum sensor to indicate that more than one interleaf sheet 30 has been picked up. One example addresses the porosity of the interleaf sheets 30 with a bellows type (not shown) pick up end effector 80 in conjunction with the use of the riffler 95.

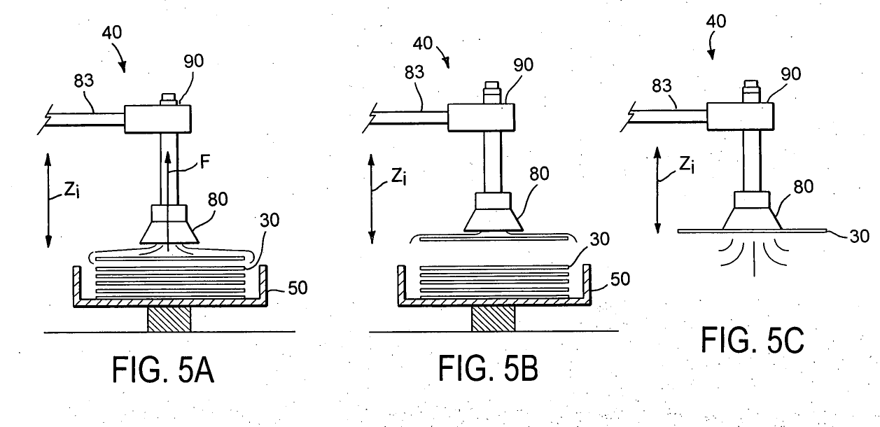

In this way, it is be possible to “float” a top sheet the interleaf stack 30 up against a descending interleaf end effector 80 with a riffling action, and thereby pick up the floating interleave sheet 30 without having to lower the end effector 80 beyond a top interleaf sheet 30 (i.e., and pressing a top interleaf sheet 30 against the lower sheets in the interleaf stack 30). Further, the interleaf sheet 30 is generally extremely thin and flexible, making proximity detection more difficult. Accordingly, the system 10 can include an interleaf end effector 80 which is configured to both apply positive and negative pressure (vacuum) in a predetermined sequence to the interleaf sheet 30 through the end effector 80. This permits very easily adjustable interaction forces (pressures) between the interleaf end effector 80 and the interleaf sheet 30. This is particularly the case if the interleaf end effector 80 is configured such that it can interact with the often dynamically changing shape of the interleaf sheet 30. In a preferred example, the end effector 80 of the transfer arm 40 first applies a positive pressure to a top interleaf sheet 30. The positive pressure from the end effector 80 generates a lift force on the top interleaf sheet 30 such that the top interleaf sheet 30 separates from the interleaf stack 30 and rises to engage the diffuser 10 of the end effector 80. A lift force that develops on the top interleaf sheet 30 in response to a positive pressure applied by the interleaf end effector 80 is described by a Bernoulli equation for fluid flow along a streamline. As the air flow from the interleaf end effector 80 and over the upper surface of the interleaf 30 is greater than the air flow over the lower surface of the interleaf 30, the average pressure on the lower surface of the interleaf 30 is greater than the average pressure on the upper surface of the interleaf 30. Accordingly, a net upward force, the lift force F (FIG. 5A) results.

When the interleaf sheet 30 reaches and engages the diffuser 110, a sensor determines a reduction in pressure to the transfer arm 40 and the system 10 next applies a vacuum to the interleaf sheet 30 to secure the interleaf sheet to the end effector 80 for transport. The use of this interleaf end effector 80 results in a highly reliable interleaf transfer mechanism independent of the porosity and geometry of the interleaf sheet 30.

In operation, the operation of the transfer arm 40 for the moving the interleaf sheet 30 to the wafer shipper 55 is described as follows. After picking up an interleaf sheet 30 the transfer arm 40 rotates over the wafer shipper 55 and releases the interleaf sheet 30 to allow it to float gently downward into the wafer shipper 55. A sensor positioned adjacent to the wafer shipper 55 (or on one of the arms 35, 40) can be used to detect whether there is a wafer 25 present in the wafer shipper 55 before releasing the interleaf sheet 30. Unloading of the interleaf sheet 30 can be accomplished by rotation of the transfer arm 40 for release into the interleaf recycle bin 98 (FIG. 1). In one example, during unloading of wafer shipper 55, the riffler 97 can be used to separate the interleaf sheets 30 from the wafers 25.

Referring to FIG. 5A, the transfer arm 40 is moved in Zᵢ and θᵢ (FIGS. 4A and 4B) directions to one of its end points in its travel range whereby a home switch (not shown) is sensed that sets a position of the transfer arm 40 with respect to a coordinate system of system 10. The transfer arm 40 is then rotated to a “pick interleaf position”. At this point, the transfer arm 40 senses the vertical position of the interleaf sheet 30. The transfer arm 40 then awaits further command. The transfer arm 40 is commanded to retrieve an interleaf 30.

This causes the interleaf end effector 80 to move downward into the interleaf holder 50. Depending on the type of grasping force, a force is enabled as the interleaf end effector 80 travels to the pick up point of the next interleaf 30. Referring to FIG. 5B, feedback sensing provides confirmation that an interleaf 30 has been positively captured by the end effector 80 and can be transferred to the wafer shipper 55. Referring to FIG. 5C, the transfer arm 40 then retracts to a safe Zᵢ height and then rotates to the wafer shipper 55 and lowers the interleaf sheet 30 into the wafer shipper 55. The grasping force is then removed and the interleaf 30 transferred to the shipper 55. The interleaf end effector 80 of the transfer arm 40 can include a sensor (not shown) to detect material properties of the interleaf sheet 30 using, for example, differential pressure, reflectance, imaging, capacitance or inductance.

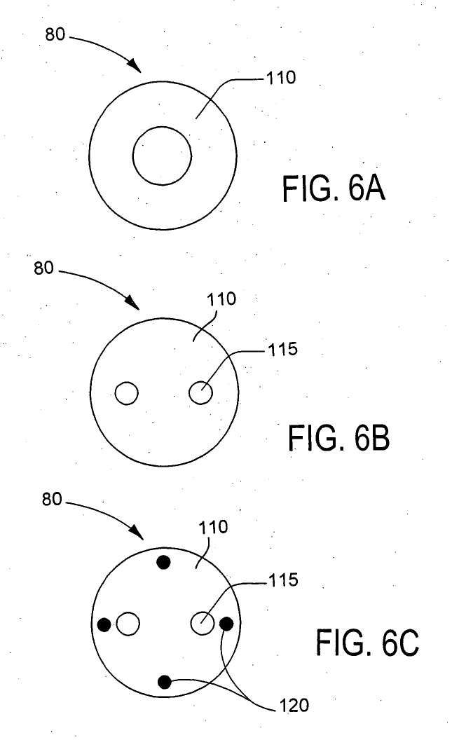

As shown in FIG. 6A, the interleaf end effector 80 can include a large open diffuser 110 for providing negative or positive pressures to the interleaf sheets 30. Alternatively, as shown in FIG. 6B, the interleaf end effector 80 can include a number of apertures 115 arranged in a configuration for optimized capture and release of an interleaf sheet 30. In a further example, shown in FIG. 6C, the interleaf end effector 80 includes a number of electrodes 120 to provide an electrostatic charge for capturing the interleaf sheet 30. The interleaf end effector 80 can include both the apertures 115 and the electrodes 120 for application of both pressure (negative and positive) and electrostatic forces for manipulation of the interleaf sheet 30.

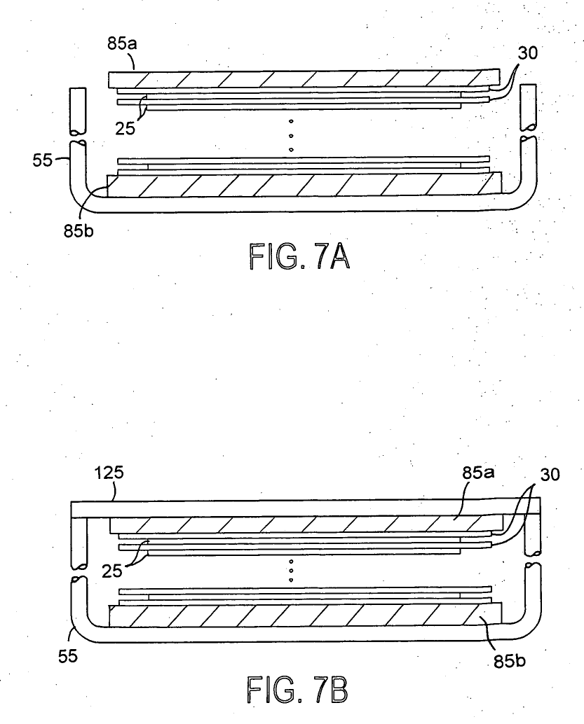

As shown in FIGS. 7A and 7B, a number of semiconductor wafers 25 are carefully stacked into the wafer shipper 55 and an interleaf sheet 30 is placed between each wafer 25 as the wafers 25 are stacked into the wafer shipper 55. The interleaf 30 protects the wafers 25 from physical or electrostatic damage that could occur during loading, unloading or transportation. Typically the interleaf 30 is made from anti-static material, such as a carbon fiber matrix, or for example, Tyvek®, sometimes referred to as “Tyvac”. The wafers 25 are typically placed face down in the wafer shipper 55 to accommodate vacuum handling by the wafer arm 35. The wafer end effector 60 applies vacuum to the back side (or bottom) 75 of the wafer 25 to avoid damaging the top surface of each wafer 25 being handled. The wafers 25 can be further protected with top and bottom layers of open-celled foam 85a, 85b on the top and/or bottom of substrate stack. Each of the constituent components of the loaded wafer shipper 55, the wafers 25, the interleaf sheets 30 and the foam layers 85 are placed in a particular sequence before the cover 125 (FIG. 7B) is secured to the top of the wafer shipper 55 for transport.

After the wafer shipper 55 is loaded with wafers 25 and interleaf sheets 30, the stack cover 125 (FIG. 7B) is attached to the wafer shipper 55, and several wafer shippers 55 can be placed in a shipping container (not shown) for bulk shipment. One advantage of the methods of system 10 are a possible reduction in wafer 25 breakage and a decrease in shipping volume reduction as compared to regular wafer shipping boxes (in some case, offering a reduction in shipping volume by an approximate factor of four). In other examples, the handling of wafers 25 and interleaf sheets 30 are handled with automated arms 35, 40 as described above, while the handling of the wafer shipper 55 and the respective cover 125 are performed manually.

In some of the examples, one or more scanners are included in the system 10. For example, a scanner (not shown) disposed on the wafer arm 35 can be used to scan the wafer shipper 55 for the position of the wafer, cross-slotted and double-slotted wafers. The scanner performs a preliminary scan on the wafer shipper 55 to check if the foam layer 85a, 85b is present before packing/loading of the wafer shipper 55. The scanner can be used to store the height of the substrate stack. The scanner can check the height of the interleaf sheets 30 and provide a warning event such as, for example, a “low” warning which will allow one cassettes 45a or 45b to run, an “out” warning if the cassettes 45a, 45b are depleted such that there is not enough to run one more lot of wafers 25 and an “OK” if level is high. The warning events can be stored and the count decremented so scanning could be as required.

In one example, the transfer arm 40 and the wafer arm 35 can run asynchronously with the transfer arm 40 checking status before releasing the interleaf sheet 30 and the wafer arm 35 checking status before moving over the wafer shipper 55. In this example, the transfer arm 40 is configured to swing over the wafer shipper 55 but above the wafer arm 35 release position. In one example, system software can be configured to check position switches of the wafer and transfer arms 35, 40 to preclude potential collision of the wafer and transfer arms 35, 40.

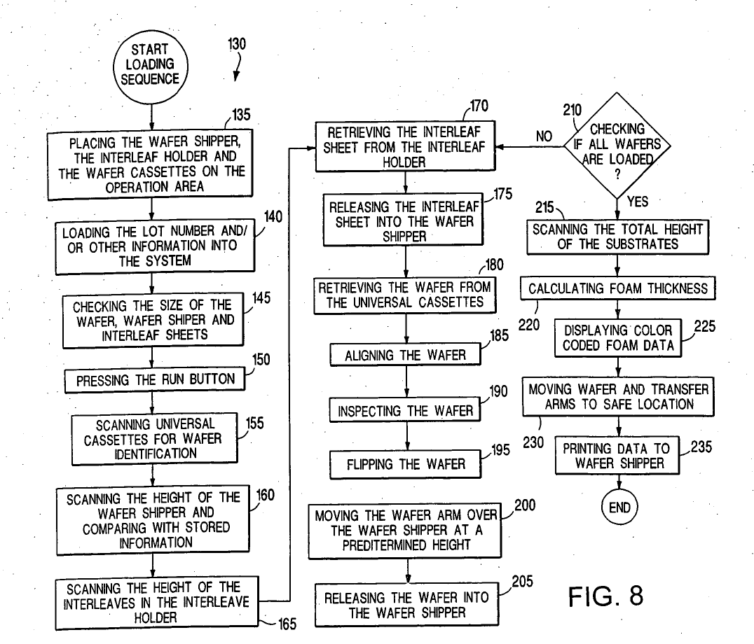

Referring to FIG. 8, a process 130 for packing the wafer shipper 55 includes placing (135) the wafer shipper 55, the interleaf holder 55 containing interleaf sheets 30 and the wafer cassettes 45a, 45b containing wafers 25 on the operation area 20. If desired, an operator (not shown) can insert a layer of packing foam 85b into a base area of the wafer shipper 55 before filling the shipper with substrates 25, 30. In some examples, after loading the above materials and holders, a system controller display (not shown) indicates what type and/or thickness of foam to place in the wafer shipping 55 before loading and to place on top of the substrates 25, 30 after loading and before placing a cover (FIG. 7B) on the wafer shipper 55 for shipping. In some examples, the system controller display can indicate a color code corresponding to the color of the required foam packing material 85a, 85b.

Process 130 loads (140) a lot number and/or other relevant information into the system 10 and checks (145) that the sizes of the wafers 25, wafer shipper 55 and interleaf sheets are consistent. Process 130 presses (150) a run button which is illuminated on the flat panel display, for example, disposed within the drawer 33 (FIG. 1) on the enclosure 15 when the aforementioned steps are complete. Process 130 scans (155) the universal cassettes 45a, 45b with the wafer arm 35 for identification of filled slots, cross-slotted and double-slotted wafers. Process 130 scans (160) the height of the wafer shipper 55 and checks base line against stored information regarding base height with foam layer 85b in place and scans (165) the height of the interleaf sheets 30 in the interleaf holder 50. This information can be obtained in the set up of the system 10 by scanning the wafer shipper 55. The scanner checks the height of the interleaf sheets 30 in the interleaf holder 50. The transfer arm 40 swings over interleaf holder 50 and descends and picks up interleaf sheet 30. All systems go to a warning status.

Process 130 retrieves (170) an interleaf sheet 30 from the interleaf holder 50 with transfer arm 40. The transfer arm 140 rotates over the interleaf holder 50 and descends to retrieve an interleaf sheet 30 with interleaf end effector 80. Process 130 releases (175) the interleaf sheet 30 from the end effector to float down into the wafer shipper 55. The transfer arm 40 repeats the sequence for the next interleaf sheet 30.

At approximately the same time, the process 130 retrieves (180) the wafer 25 from the universal cassettes 45a, 45b with the wafer arm 25 and aligns (185) the wafer 25 by placing the wafer 25 on the prealigner 57 (if a wafer ID is required). The prealigner 57 aligns the wafer 25 and the wafer ID is read. If a remote camera is used, a robotic translation of the wafer ID is performed. The wafer arm 35 picks the wafer 25 from prealigner 57 and withdraws from the prealigner 57.

Process 130 inspects (190) the wafer 25 at the prealigner 57. Wafers 25 found to have defects can be automatically classified and moved to the reject cassette (not shown) or manually classified and either a proceed or reject decision is made which would have some impact on throughput of the system 10. Process 130 flips (195) the wafer 25 one-hundred-eighty degrees, by rotating the wafer arm 35, and moving the wafer 25 towards the wafer shipper 55. The system 10 checks the arms 35, 40 sequence and the interleaf/wafer sensors. Process 130 moves (200) the wafer arm 35 over the wafer shipper 55 at a predetermined height and releases (205) the wafer 25 to float into the wafer shipper 55. Process 130 checks (210) whether all of the wafers 25 have been loaded into the wafer shipper 55 based on information retrieving during loading 140 and the number of wafers retrieved 180 and released 205. The sequence of retrieving 170 through releasing 205 is repeated until all wafers 25 in the universal cassettes 45a, 45b are loaded into the wafer shipper 55.

After loading the wafer shipper 55, process 130 scans (215) the height of the substrates 25, 30 and the foam layers 85a, 85b with the wafer arm 25 and measures the total height. The system 10 compares the measured height to a theoretical compressed stack height. Process 130 calculates (220) a requisite thickness of the foam layer 85a (FIGS. 7A, 7B) to complete the substrate stack and displays (225) a color code correspondign tot he foam layer 85a. Process 130 moves (230) the wafer and transfer arms 35, 40 to safe locations to allow the wafer shipper 55 to be closed with cover 125 (FIG. 7B) and removed from the operation area 20. If either an integrated or remote printer (not shown) is installed on the system 10, process 130 prints (235) the wafer lot number and/or other data on an adhesive label (not shown) which is applied to the wafer shipper 55.

Unloading is generally the reverse of loading with the exception that when the wafer 25 is lifted from the wafer shipper 55, there can be a variable pause to allow static electricity to bleed away from the wafer 25 before continuing with the unloading cycle as explained above. Unpacking the interleaf sheets 30 from the wafer shipper 55 is the reverse of loading in that the interleaf sheets 30 are returned to the interleaf holder 50. The interleaf sheets 30 can also be jettisoned to the recycle bin 98 (FIG. 1) after the transfer arm 40 removes the interleaf sheet 30 from the wafer shipper 55.

The transfer arm 40 provides enhanced throughput of the system 10. A rate limiting scenario can occur when the transfer arm 40 is just keeping pace with the movement of the wafer arm 35. The wafer and transfer arms 35,40 can be mechanically tuned and the only software requirements entail reading the sensors before the next operation particularly in Z direction of the arms 35, 40, i.e., before rotation, the system checks the position in the Z direction. The querying of the Z position sensors can be designed to minimize delays and maintain throughput of the system 10. The actual retrieval of the interleaf sheet 30 is activated by a hardware interrupt. The sensor-detecting of wafers 25 and interleaf sheets 30 in wafer shipper 55 is active and will provide a warning and stop operation with the occurrence of any malfunction.

The load position of the wafer arm 35 is beneath the transfer arm 40 and accordingly, the system 10 can be asynchronous up to the point where the wafer arm 35 is about to extend the wafer 25 over the wafer shipper 55, whereupon the position of the transfer arm 40 and the interleaf vacuum status is checked against the interleaf/wafer sensor for the presence of the interleaf sheet 30 before proceeding to load the wafer 25.

A number of examples have been described. Nevertheless, it will be understood that various modifications can be made without departing from the spirit and scope of the system. For example, the wafer arm 35 and/or transfer arm 40 can be three-degrees of freedom articulating robotic arms (with movement possible in the Z, 0 and R directions, for example). The placement of the wafer and transfer arms 35, 40 can be modified upon the operation area 20 for a number of configurations. For instance, the wafer end effector 60 can be configured to engage and manipulate interleaf sheets 30 and the interleaf end effector 80 can be configured to engage and manipulate wafers 25. Accordingly, other examples are within the scope of the following claims.

What is claimed is:

1. A system comprising:
a first robotic arm assembly for capturing and releasing a semiconductor wafer, the first robotic arm having at least two degrees of freedom;
a second robotic arm for capturing and releasing an interleaf, the second robotic arm having at least two degrees of freedom; and
a controller for actuation of the first and second robotic arms, the first and second robotic arms operating substantially simultaneously.

2. The system according to claim 1 wherein the second robotic arm comprises:
a transfer arm having a first end and a second end, the arm being mounted to a second arm base;
a counterweight attached to the first end of the transfer arm; and
an end effector attached to a lower portion of the chuck assembly.

3. The system according to claim 2 wherein the end effector is configured to apply variable pressure forces to capture and release the interleaf.

4. The system according to claim 3 wherein the end effector is configured to sequentially apply negative and positive pressures to capture and release the interleaf.

5. The system according to claim 3 further comprising a sensor to detect a proximity and engagement of the interleaf with the end effector.

6. The system according to claim 5 wherein the sensor uses differential pressure, reflectance, imaging, capacitance or inductance to detect proximity and engagement of the interleaf.

7. The system according to claim 3 further comprising a sensor to detect the material properties of the interleaf.

8. The system according to claim 7 wherein the sensor uses differential pressure, reflectance, imaging, capacitance or inductance to detect the material properties of the interleaf.

9. The system according to claim 3 wherein the end effector arm further comprises electrodes to provide an electrostatic charge for capturing the interleaf.

10. The system according to claim 2 wherein the end effector is slidably disposed in a substantially vertical orientation at the second end of the transfer arm.

11. The system according to claim 10 wherein the end effector is configured to vertically actuate independently of the base.

12. The system according to claim 1 wherein at least one of the robotic arms is pneumatically actuated.

13. The system according to claim 1 wherein at least one of the robotic arms is actuated with electric servo motors.

14. The system according to claim 1 comprising an interleaf cassette holder including a pneumatic separator for separation of the interleafs.

15. An assembly comprising:
a transfer arm having a first end and a second end, the arm being mounted to a second arm base;
a counterweight attached to the first end of the transfer arm;
a chuck assembly attached to the second end of the transfer arm; and
an end effector attached to a lower portion of the chuck assembly, the end effector configured to apply positive and negative pressures to a substrate.

16. An assembly according to claim 15 wherein the end effector is configured to sequentially apply positive and negative pressures to the substrate.

17. An assembly according to claim 15 further comprising a sensor to detect the material properties of the substrate when coupled to the end effector.

18. A method comprising:
providing a processing system having first and second robotic arms, the first robotic arm having a first end effector for capture and release of a semiconductor wafer, the second robotic arm having a second end effector for the capture and release of an interleaf sheet;
positioning the second robotic arm such that the second end effector is proximate to interleaf sheets;
applying a positive pressure through the second end effector to the interleaf sheets to separate an upper-most interleaf sheet from remaining sheets;
applying a negative pressure through the second end effector to retain the upper-most interleaf sheet against the second end effector; and
transporting the upper-most interleaf sheet from a first location to a second location; and
releasing the upper-most interleaf sheet from the second end effector.

19. The method according to claim 18 wherein the interleaf sheet is released into a enclosure and further comprising positioning the first robotic arm for capturing the semiconductor wafer from a first location and releasing the semiconductor wafer to a second location within a wafer shipper before each release of the upper-most interleaf sheet from the second end effector.

20. The method according to claim 19 further comprising capturing the semiconductor wafer by applying negative pressure through the first end effector and releasing the wafer by applying ambient pressure through the first end effector.

21. The method according to claim 18 further comprising reading a wafer ID for complete wafer tracking from the first location to the second location.

22. The method according to claim 18 further comprising storing and sending data for label printing of the semiconductor wafer with a label printer.

23. The method according to claim 18 further comprising inspecting the semiconductor wafer for defects such as edge damage.

24. The method according to claim 18 further comprising sorting the semiconductor wafers into a plurality of second locations.
